(19) United States
(12) Patent Application Publication
(10) Pub. No.: US 2014/0101047 A1
(43) Pub. Date: Apr. 10, 2014

(54) System and Method for Authenticating a Payment Transaction

(71) Applicant: BARCLAYS BANK PLC, London (GB)

(72) Inventors: James Gardiner, Buckinghamshire (GB); Colin McSkeane, Bedfordshire (GB)

(73) Assignee: BARCLAYS BANK PLC, London (GB)

(21) Appl. No.: 13/660,544

(22) Filed: Oct. 25, 2012

(30) Foreign Application Priority Data
Oct. 9, 2012 (GB) 1218090.7

(51) Int. Cl. G06Q 20/40

(52) U.S. Cl. CPC G06Q 20/409
USPC 705/44

(57) ABSTRACT

In an electronic payment transaction, a mobile merchant device captures customer card details using an integrated camera. The customer enters card security details on a touch-screen of the mobile merchant device, which also captures fingerprint data from the customer. The fingerprint data are stored in a transaction record, for non-repudiation purposes.

### FIELD OF THE INVENTION

This invention relates to a transaction payment system, and more particularly to a system and method for providing enhanced authentication of card payment transactions.

### BACKGROUND OF THE INVENTION

Payment transaction systems that use a mobile data terminal to handle ‘Point of Sale’ (POS) credit/debit card transactions for a merchant are known. Typically, the merchant's data terminal can be a mobile smartphone, tablet computer or portable computing device with cellular data communication capabilities, such as General Packet Radio Service (GPRS), Enhanced Data Rates for GSM Evolution (EDGE) or 3G (3^{rd} generation mobile telecommunications technology), and capable of running a payment application. The payment application preferably provides accounting functions for the merchant, such as calculating a total bill, printing receipts, providing summaries of transactions etc. The payment application also communicates electronically with a transaction processing back-end server to process and settle the transactions.

A payment card reader may be provided as a peripheral device in communication with the data terminal. Alternatively, the merchant's data terminal may capture the customer's card details using a scanner or camera, for example as disclosed in US-A-2010/0008535 (Jumio). This technique does not require a card reader, so may be implemented on a standard smartphone with an integrated camera. However, such a technique is inherently less secure than the commonly used ‘Chip and PIN’ card reader where a computer chip is embedded in a smartcard and a personal identification number (PIN) is provided by the consumer for completion of a transaction.

As such card payment systems become more prevalent, there is a need for improved systems and techniques to provide greater security for transactions and reduce the risk of fraudulent use.

### STATEMENTS OF THE INVENTION

Aspects of the present invention are set out in the accompanying claims.

According to one aspect of the present invention, there is provided a method and system for authenticating a payment transaction at a merchant device, in which the customer is required to enter authentication data, and biometric data is captured as the customer enters the authentication data. The biometric data is stored in a transaction record for later use in the case of attempted repudiation.

The authentication data may be entered on a touch-sensitive screen which is able to capture fingerprint data during the entry of the authentication data. Advantageously, the customer is not required to provide fingerprint or other biometric data as a separate step.

Preferably, the merchant device captures card details for the transaction without the need for a dedicated card reader. For example, a camera integrated with the merchant device may be used to capture an image of the card, from which card details are extracted by optical character recognition (OCR).

In a further aspect of the present invention there is provided a mobile device, an authentication system, and associated computer programs arranged to carry out the above method.

### BRIEF DESCRIPTION OF THE DRAWINGS

There now follows, by way of example only, a detailed description of embodiments of the present invention, with references to the figures identified below.

FIG. 1 is a block diagram showing the main components of a payment processing system according to an embodiment of the invention.

FIG. 2 is a flow diagram illustrating the main processing steps performed by the system of FIG. 1.

FIG. 3 is a schematic diagram of a display screen for authentication data entry.

FIG. 4 is a diagram of an exemplary computer system on which one or more of the functions of the embodiment may be implemented.

### DETAILED DESCRIPTION OF EMBODIMENTS OF THE INVENTION

### Card Payment Background

Card payments are a way of paying for goods and services without cash changing hands. The presentation of the card details and appropriate cardholder authentication guarantee the merchant payment. A conventional card payment system is made up of a number of components: cardholder, merchant, acquirer, scheme and card issuer. As is appreciated by those skilled in the art, the cardholder is the consumer purchasing goods or services with a card, the merchant is selling the goods or services to the consumer, the acquirer is an intermediary that functions to process the transaction on behalf of the merchant and card issuer, the scheme refers to the entity operating a specific transaction protocol (i.e., rules for the interchange) in which the cardholder, merchant, merchant acquirer and card issuer have agreed to participate, and the card issuer is the bank or other entity offering the cards directly to the consumer and ultimately assuming financial liability for the transaction by providing the cardholder with a line of credit.

In the normal process the cardholder presents his card (or token) to the merchant in order to pay for goods or services rendered; this transaction may take place over any one of a number of channels (in store or via the Internet, for example). The merchant, through his acquirer, is set up to accept different card types by scheme (Visa®, MasterCard®, Amex®, credit, debit, for example). When a card is presented, the cardholder is authenticated (by Personal Identification Number, PIN, passcode, or Card Verification Value, CV2, for example), subject to channel and merchant capability, and the transaction is submitted to the merchant's acquirer (referred to herein as “merchant acquirer”) for authorisation. Authorisation and authentication of the merchant and/or cardholder may instead or additionally be handled through a trusted third party authentication system that is known to the merchant acquirer.

Once the transaction is received, the merchant acquirer routes the authorisation transaction, in real time, to the relevant scheme based upon card type. The scheme provides isolation between merchant acquirers and card issuers for routing of authorisations, settlements and funds movement. The merchant acquirer doesn't need to know who the card issuer is, just which scheme to route it to which is determined by Bank Identification Number (BIN).

The card issuer authorises the transaction based upon the cardholder's balance and other risk/fraud criteria and returns an authorised message and authorisation code to the scheme, which routes it back to the merchant acquirer who sends it to the merchant. The merchant then confirms the sale, which posts a settlement transaction to the merchant acquirer; this is a mandate to make the payment and move funds. The settlement transaction is routed between merchant acquirers and card issuers via the scheme.

Technical Architecture

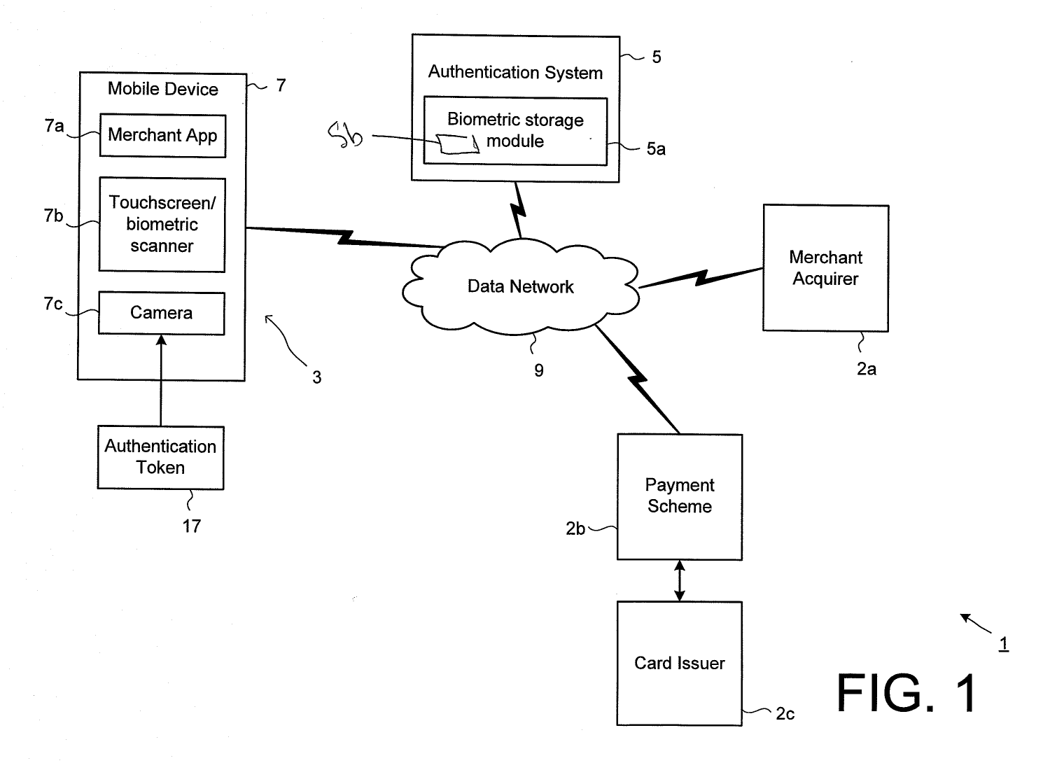

Referring to FIG. 1, a payment transaction system 1 according to an embodiment of the invention is disclosed. The present payment transaction system 1 provides a computer-implemented method of authenticating a payment transaction between a merchant and a customer in an electronic payment system. The method includes the steps of initiating a transaction at a merchant system 3, capturing biometric data from the customer while receiving authentication data as input from the customer at the merchant device, storing the biometric data in a payment transaction record, and authenticating the transaction by means of the authentication data.

With this foregoing methodology in mind, the present payment transaction system 1 comprises a merchant system 3 for handling payment transactions, such as credit/debit card transactions, through a merchant application 7a running on a mobile device 7. In a typical payment transaction process, the merchant application 7a receives data identifying goods and/or services associated with the payment transaction, applies discounts or vouchers, determines the total amount due for payment, and initiates authentication of an payment token 17 presented by the customer (that is, the cardholder or token holder). The merchant application 7a obtains details of the payment token 17 before the payment transaction can be settled and completed.

In the present embodiment, the payment token 17 is a credit or debit card of conventional type, carrying at least a card number, expiration date and cardholder name on the front side and a card security code on the reverse side.

The mobile device 7 can be a mobile smartphone, tablet computer or portable computing device, or the like, and communicates with a transaction processing module, in particular, an authentication system 5 via a data network 9. The merchant application 7a is preferably secured by means of a passcode and information associated with a payment transaction can be provided via the secured merchant application 7a running on the mobile device 7. Electronic data communication by the merchant application 7a may also be encrypted to enhance the overall security of the present system.

The merchant system 3 is connected to an authentication system 5, a merchant acquirer 2a, the payment scheme 2b and the card issuer 2c via a data network 9. The data network 9 may be any suitable data communication network such as a wireless network, a local- or wide-area network including a corporate intranet or the Internet, using for example the TCP/IP protocol, or a cellular communication network such as GPRS, EDGE or 3G, for example. Such communication protocols are of a type that are known per se in data networks and need not be described further.

As is appreciated, components of the merchant system 3 are in communication with a merchant acquirer 2a, payment scheme 2b and card issuer 2c components over the data network 9, which are typically provided for authorizing and settling card payment transactions as described in the section above, and need not be described further.

In this embodiment of the present invention, additional authentication is handled through the authentication system 5 hosted by a trusted third party that is known to the merchant acquirer 2a. Alternatively, it is appreciated the authentication system 5 may be provided as a component of the merchant acquirer 2a. As will be described below, this authentication system 5 provides an authentication security check prior to authorisation processing of a payment transaction, and additionally stores biometric information captured from the customer during the authentication security check, in a biometric storage module 5a.

As part of the requirement that the merchant system 3 collect both authentication data and biometric data in conjunction with the processing of a card transaction, the mobile device 7 includes a digital camera 7c for scanning or imaging the payment token 17 so as to capture the card details (for example, card number, cardholder name, expiration date, etc.) at least from the front side of the card. The digital camera 7c is controlled by the merchant application 7a to capture a digital still or moving image of the front side of the card. The merchant application 7a obtains the card details from the digital image using an Optical Character Recognition (OCR) process.

The mobile device 7 also includes a touch-sensitive screen 7b that is able to retrieve biometric information such as fingerprint information from a user as the user touches the screen to enter a card security code required for the authentication process. Examples of such screens are disclosed in US-A-2012/0154296 (Microsoft) and US2012/0092127 (Qualcomm), which are incorporated herein by reference. Preferably, at least part of the touch-sensitive screen 7b has sufficient sensing resolution to detect the pattern of the user's fingerprint as the user touches the screen. An advantage of such a screen is that the user's fingerprint is captured without requiring a specific fingerprint scanning step; instead, fingerprint information is captured while the user performs another type of interaction with the touch-sensitive screen 7b. Partial fingerprint information may be captured from each of multiple touch interactions, and merged to form more complete fingerprint information.

Payment Authentication Process

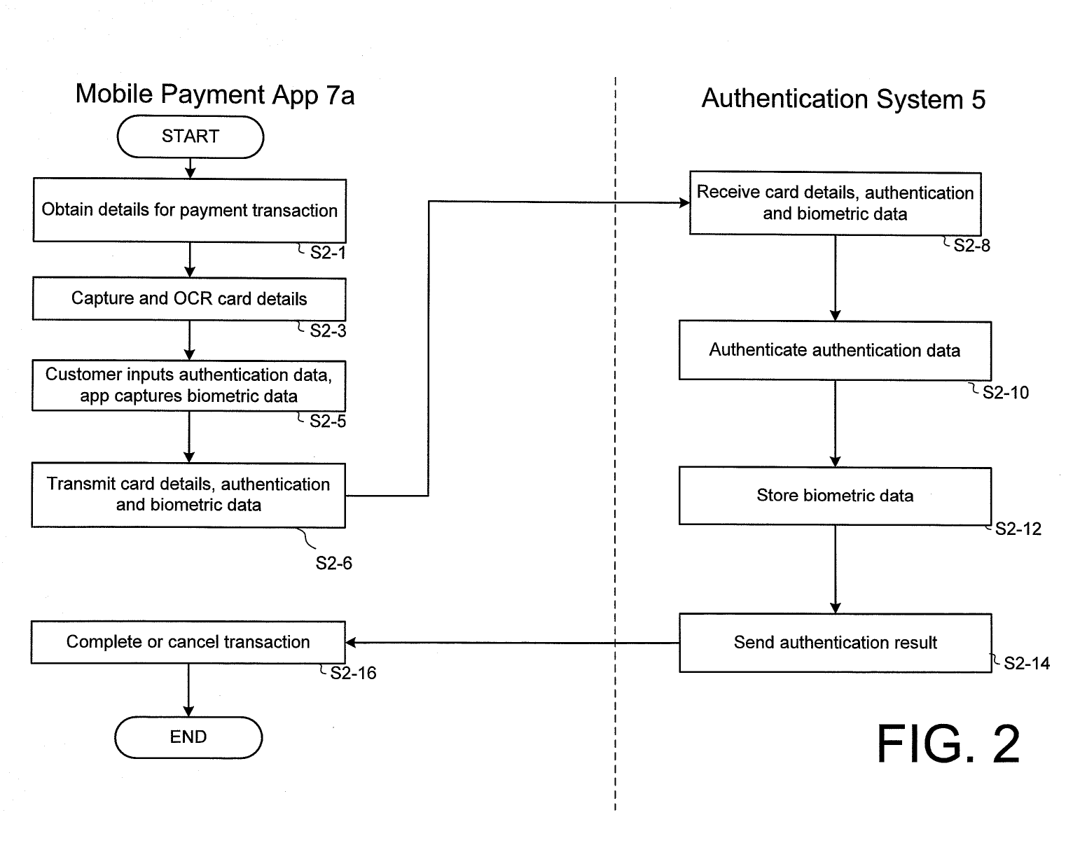

An embodiment of a process of payment authentication will now be described with reference to FIG. 2, to illustrate the technical advantage of the payment transaction system embodiment described above.

The process begins at step S2-1 where details for a new payment transaction are obtained by the merchant application 7a running on the mobile device 7. The transaction details typically include a payment amount to be transferred and data identifying the transaction, such as the time and date of the transaction and a description of the associated goods or services. The merchant application 7a may scan codes (such as 1D barcodes or 2D QR codes) associated with the goods or services to obtain details of the transaction.

At step S2-3, the merchant application 7a captures a digital image of the front side of a card presented by the customer and obtains the card details using an OCR process on the digital image, as described above. This conveniently avoids the customer or merchant having to enter the card number and other details manually.

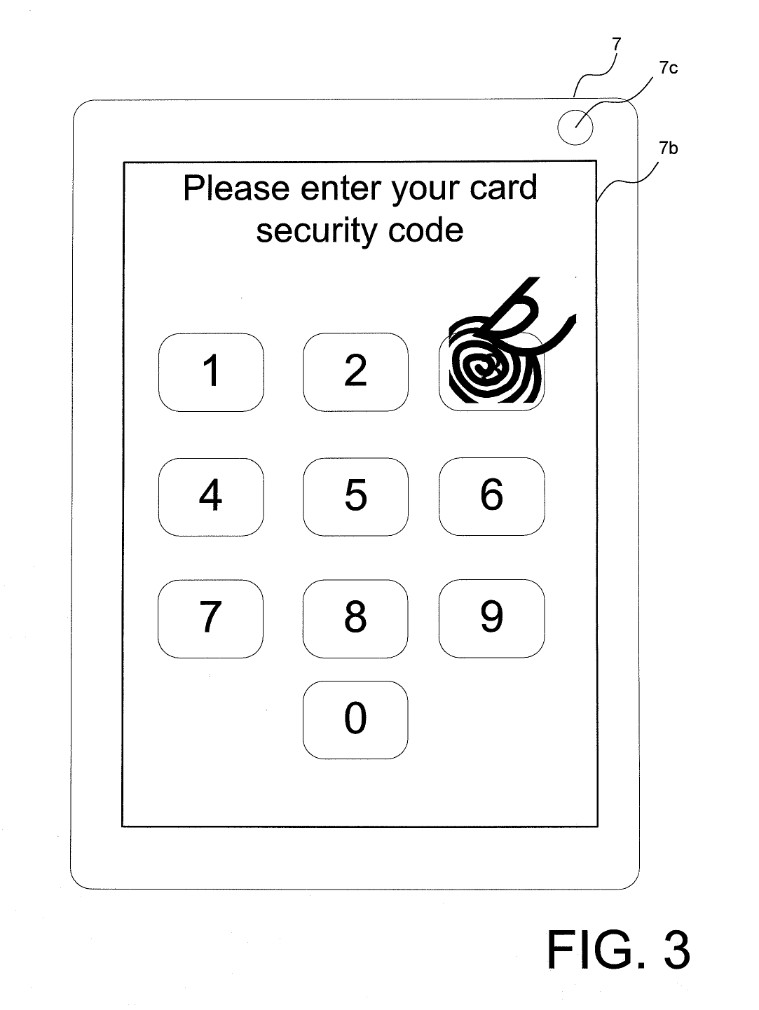

At step S2-5, the merchant application 7a displays on the touchscreen 7b a data entry screen to the customer, prompting the customer to enter their card security code, such as the CV2 code. An example of the data entry screen is shown in FIG. 3, in which virtual numeric keys are displayed. As represented by the finger and fingerprint, the screen 7b captures at least a partial fingerprint when the customer touches the screen 7b with a finger, as well as recording the number pressed. Since the customer is required to enter multiple numbers for the card security code, the screen 7b may capture multiple partial or complete fingerprints.

In this embodiment, the merchant application 7a does not attempt to authenticate the captured fingerprints, since there is no fingerprint data available for the customer. In particular, any fingerprint data stored on a chip on the customer's card cannot be read, since the mobile device 7 does not include a chip reader. Instead, the merchant application 7a records the captured fingerprint data for storage as part of a payment transaction record, as will be explained below. The merchant application 7a may however determine whether no significant fingerprint data has been captured, for example as a result of the customer using a stylus, and may then prompt the customer to re-enter the authentication data using a finger.

In preparation for the transmission of the biometric data gathered by the merchant application 7a, the merchant application 7a preferably encodes and/or compresses the captured fingerprint data using a standard format for fingerprint data, such as disclosed in ANSI/NIST-ITL 1-2011 Special Publication 500-290, ‘Data Format for the Interchange of Fingerprint, Facial & Other Biometric Information’.

In addition to the required card security card as discussed above, the merchant application 7a may request input of alternative or additional authentication information, such as the cardholder's postal (zip) code for comparison with the cardholder's registered billing address.

At step S2-6, the merchant application 7a transmits the captured authentication and biometric (e.g. fingerprint) data together with the captured card details, to the authentication system 5 where the data is received, at step S2-8. At step S2-10, the authentication system 5 uses the card details to access a corresponding cardholder record and authenticate the authentication data against the cardholder record. It is appreciated the cardholder record is typically held by the card issuer 2c, so the authentication system 5 may delegate the authentication step to the card issuer 2c, via the payment scheme 2b, and receive an authentication response from the card issuer 2c. Alternatively, the merchant application 7a may send the authentication data to the merchant acquirer 2a for authentication, and send the biometric data to the authentication system 5.

At step S2-12, the authentication system 5 stores the received biometric data in a cardholder or payment transaction record 5b maintained on the biometric storage module 5a. The cardholder or payment transaction record 5b may subsequently be retrieved if the cardholder seeks to repudiate the transaction i.e. denies that the cardholder authorised the transaction. The cardholder may then be required to provide a fingerprint scan for comparison with the biometric data in the cardholder or payment transaction record.

The authentication system 5 may optionally validate the biometric data to ensure that it corresponds to one or more valid fingerprints. In a case where the authentication system 5 has access to cardholder records including authentic fingerprint data, the authentication system 5 may authenticate the received biometric data against the cardholder records. Alternatively, the authentication system 5 may store previously received biometric data from previously authenticated transactions in a card or cardholder record, and authenticate the received biometric data for the current transaction against the previously received biometric data.

At step S2-14, the authentication system 5 sends an authentication result to the merchant application 7a, dependent on the authentication of the authentication data and optionally on the validation/authentication of the biometric data. At step S2-16, the merchant application 7a may complete or cancel the transaction, depending on the received authentication result.

Optionally, if the authentication system 5 fails to authenticate the authentication data and/or the biometric data, it may send an alert message to an address registered in the cardholder record. The address may be a mobile number for sending a text or multimedia message, an email address, or a postal address.

In this way, acquirers and merchants in the payment transaction system are provided with enhanced security and non-repudiation of payment transactions.

### Alternative Embodiments

It will be understood that embodiments of the present invention are described herein by way of example only, and that various changes and modifications may be made without departing from the scope of the invention.

For example, in the exemplary embodiment described above, the biometric data comprises fingerprint data and the authentication data entry means comprises a touch-sensitive screen. Other combinations may be envisaged which nevertheless allow biometric data to be captured during authentication data entry. In one alternative, the customer may be required to speak authentication data into a microphone of the mobile device; the authentication data is captured using a speech recognition process, and the biometric data is captured as a voiceprint characteristic of the speaker. In another alternative, the authentication data entry means may be a touchpad separate from any display screen, the touchpad also being able to capture fingerprint data.

The card details may be captured by means other than a digital image. For example, the card or other payment token may include a near field communication (NFC) tag or a radiofrequency identification (RFID) tag which can be read by the mobile device 7. Alternatively, but less preferably, the customer or merchant may be required to enter the card details manually on the mobile device 7.

The division of operations between the merchant application 7a and the authentication system 5 may differ from that described in the embodiment above. For example, the digital image of the card may be sent to the authentication system 5 for OCR processing. The fingerprint data may be sent to the authentication system 5 for encoding. In either case, less processing is required by the merchant application 7a, at the expense of greater bandwidth requirements between the merchant application 7a and the biometric storage module 5a.

Alternative embodiments may be envisaged, which nevertheless fall within the scope of the following claims.

### Computer Systems

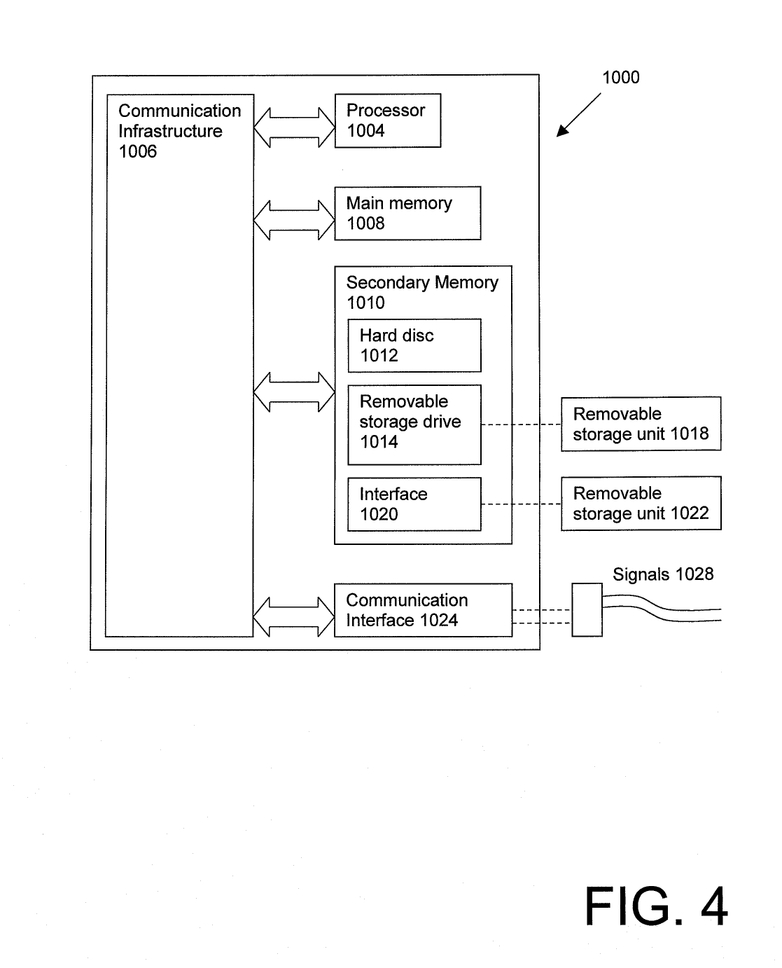

The entities described herein, such as the mobile device 7 or authentication system 5, are preferably implemented by computer systems such as computer system 1000 as shown in FIG. 4. Embodiments of the present invention may be implemented as programmable code for execution by such computer systems 1000. After reading this description, it will become apparent to a person skilled in the art how to implement the invention using other computer systems and/or computer architectures.

Computer system 1000 includes one or more processors, such as processor 1004. Processor 1004 may be any type of processor, including but not limited to a special purpose or a general-purpose digital signal processor. Processor 1004 is connected to a communication infrastructure 1006 (for example, a bus or network). Various software implementations are described in terms of this exemplary computer system. After reading this description, it will become apparent to a person skilled in the art how to implement the invention using other computer systems and/or computer architectures.

Computer system 1000 also includes a main memory 1008, preferably random access memory (RAM), and may also include a secondary memory 610. Secondary memory 1010 may include, for example, a hard disk drive 1012 and/or a removable storage drive 1014, representing a floppy disk drive, a magnetic tape drive, an optical disk drive, etc. Removable storage drive 1014 reads from and/or writes to a removable storage unit 1018 in a well-known manner. Removable storage unit 1018 represents a floppy disk, magnetic tape, optical disk, etc., which is read by and written to by removable storage drive 1014. As will be appreciated, removable storage unit 618 includes a computer usable storage medium having stored therein computer software and/or data.

In alternative implementations, secondary memory 1010 may include other similar means for allowing computer programs or other instructions to be loaded into computer system 1000. Such means may include, for example, a removable storage unit 1022 and an interface 1020. Examples of such means may include a program cartridge and cartridge interface (such as that previously found in video game devices), a removable memory chip (such as an erasable programmable read only memory (EPROM), or programmable read only memory (PROM), or flash memory) and associated socket, and other removable storage units 1022 and interfaces 1020 which allow software and data to be transferred from removable storage unit 1022 to computer system 1000. Alternatively, the program may be executed and/or the data accessed from the removable storage unit 1022 using the processor 1004 of the computer system 1000.

Computer system 1000 may also include a communication interface 1024. Communication interface 1024 allows software and data to be transferred between computer system 1000 and external devices. Examples of communication interface 1024 may include a modem, a network interface (such as an Ethernet card), a communication port, a Personal Computer Memory Card International Association (PCMCIA) slot and card, etc. Software and data transferred via communication interface 1024 are in the form of signals 1028, which may be electronic, electromagnetic, optical, or other signals capable of being received by communication interface 1024. These signals 1028 are provided to communication interface 1024 via a communication path 1026. Communication path 1026 carries signals 1028 and may be implemented using wire or cable, fibre optics, a phone line, a wireless link, a cellular phone link, a radio frequency link, or any other suitable communication channel. For instance, communication path 1026 may be implemented using a combination of channels.

The terms “computer program medium” and “computer usable medium” are used generally to refer to media such as removable storage drive 1014, a hard disk installed in hard disk drive 1012, and signals 1028. These computer program products are means for providing software to computer system 1000. However, these terms may also include signals (such as electrical, optical or electromagnetic signals) that embody the computer program disclosed herein.

Computer programs (also called computer control logic) are stored in main memory 1008 and/or secondary memory 1010. Computer programs may also be received via communication interface 1024. Such computer programs, when executed, enable computer system 1000 to implement embodiments of the present invention as discussed herein. Accordingly, such computer programs represent controllers of computer system 1000. Where the embodiment is implemented using software, the software may be stored in a computer program product and loaded into computer system 1000 using removable storage drive 1014, hard disk drive 1012, or communication interface 1024, to provide some examples.

Alternative embodiments may be implemented as control logic in hardware, firmware, or software or any combination thereof.

1. A computer-implemented method of authenticating a payment transaction between a merchant and a customer in an electronic payment system, comprising the steps of:
a. initiating a transaction at a merchant device;
b. capturing biometric data from the customer while receiving authentication data as input from the customer at the merchant device;
c. storing the biometric data; and
d. authenticating the transaction using the authentication data.

2. The method of claim 1, wherein the step of authenticating the transaction further includes using the biometric data for authentication.

3. The method of claim 1, wherein the merchant device includes a touch-sensitive surface on which the authentication data is input by the customer, the touch sensitive surface being arranged to capture fingerprint data as the consumer inputs the authentication data.

4. The method of claim 3, wherein the touch-sensitive surface comprises a touch-sensitive display screen.

5. The method of claim 1, wherein the authentication data is input as speech, and the biometric data is derived from the speech using a speech recognition program.

6. The method of claim 1, further comprising the step of receiving payment token data from a payment token presented by the customer.

7. The method of claim 6, wherein the payment token comprises a bank card.

8. The method of claim 6, wherein the step of receiving payment token data includes capturing the payment token data from a digital image of the payment token.

9. The method of claim 8, wherein the digital image is obtained using a camera integrated with the merchant device.

10. The method of claim 8, wherein the authentication data comprises a security code displayed on the payment token.

11. The method of claim 1, wherein the merchant device comprises a mobile device.

12. A payment transaction system, comprising
a merchant system for handling a payment transaction, the merchant system including a merchant application running on a merchant device, the merchant device including means for inputting authentication data and simultaneously capturing biometric data;
an authentication system evaluating the authentication data for authenticating the payment transaction; and
a storage module for storing the biometric data.

13. The payment transaction system of claim 12, wherein the authentication system further evaluates the biometric data.

14. The payment transaction system of claim 12, wherein the merchant device includes a touch-sensitive surface on which the authentication data is input by the customer, the touch sensitive surface being arranged to capture fingerprint data from said input by the customer.

15. The payment transaction system of claim 14, wherein the touch-sensitive surface comprises a touch-sensitive display screen.

16. The payment transaction system of claim 12, wherein the authentication data is input as speech, and the biometric data is derived from the speech using a speech recognition program.

17. The payment transaction system of claim 12, further including a payment token including payment token data.

18. The payment transaction system of claim 17, wherein the payment token comprises a bank card.

19. The payment transaction system of claim 18, wherein the merchant device includes a camera for capturing the payment token data via a digital image of the payment token.

20. The payment transaction system of claim 19, wherein the authentication data comprises a security code displayed on the payment token.

21. The payment transaction system of claim 12, wherein the merchant device comprises a mobile device.
